(19) United States
(12) Patent Application Publication
(10) Pub. No.: US 2011/0149396 A1
(43) Pub. Date: Jun. 23, 2011

(54) REFLECTIVE LENS WITH REFLECTIVE SHEETING

(76) Inventors: Damian Amaya, Monterrey (MX); Yadhira Cruz, Tuxpan De Rodriguez Cano (MX)

(21) Appl. No.: 12/974,353

(22) Filed: Dec. 21, 2010

Related U.S. Application Data
(60) Provisional application No. 61/288,687, filed on Dec. 21, 2009.

(51) Int. Cl. G02B 5/124

(52) U.S. Cl. 359/531

(57) ABSTRACT

A retroreflector or simple reflector assembly mounted to a road, the assembly comprising a lens having a rear surface, a shell having an outer surface, the lens mounted on the outer surface of the shell, and a reflective or retroreflective sheeting disposed between the rear surface of the lens and the outer surface of the shell thereby allowing light entering the lens from vehicle headlights to reflect efficiently back to the driver of an automotive vehicle where light is emitted from the vehicle headlights. The outer surface of the shell includes a recess adapted to accept the lens, wherein the lens sits within the recess of the outer surface of the shell. The sheeting lines the recess and is disposed between the lens and the recess of the outer surface of the shell.

### CROSS-REFERENCE TO RELATED APPLICATIONS

This application claims priority of U.S. Provisional Patent Application Ser. No. 61/288,687 filed Dec. 21, 2009, which is incorporated herein by reference

### FIELD OF THE INVENTION

The invention relates generally to road markers. In particular, the invention relates to a road marker having a increased reflective or retroreflective characteristics due to reflective sheeting behind a lens mounted on the road marker.

### BACKGROUND OF THE INVENTION

It is known to make lenses for use in items such as reflective or retroreflective road markers which have flat surfaces on one side of the lens and a plurality of shapes such as cube corners on the opposite side. Cube corners are typically plated with vacuum depositions of aluminum or another material having high reflective properties in order to perform specular reflection to provide good reflectivity. It is also known to use a glass sheet in the front of the front surface of the lens to protect an acrylic lens from abrasion when tires pass over the surface of the lens. However, such lenses are expensive to produce. The plating process is time consuming, and it is difficult to control the quality of the plating process.

### SUMMARY OF THE INVENTION

A road marker assembly mounted to a road enabling a driver to better see road divisions, the road marker assembly comprising a lens having a rear surface, a shell having an outer surface, the lens mounted on the outer surface of the shell, and a reflective or retroreflective sheeting layer disposed between the rear surface of the lens and the outer surface of the shell thereby allowing light entering the lens from vehicle headlights to reflect efficiently near back to the originating light emitted from the vehicle headlights. The outer surface of the shell includes a recess adapted to accept the lens, wherein the lens sits within the recess of the outer surface of the shell. The reflective layer lines the recess and is disposed between the lens and the recess of the outer surface of the shell.

### BRIEF DESCRIPTION OF THE DRAWINGS

FIG. 1 is a perspective view of the road marker having a cutaway portion showing the sheeting;

FIG. 2 is a close up view of the area shown in FIG. 1 illustrating the positioning of the sheeting between the lens and the shell;

FIG. 3 is an exploded perspective view of a portion of the lens contacting the sheeting;

FIG. 4 is a diagram illustrating rays of light entering the lens and bouncing back to the viewer at predetermined angles;

FIG. 5 is a cross-sectional view of an alternative embodiment showing an increased sloping angle of the lens resting within the shell; and

FIG. 6 is a perspective view of an alternative embodiment showing the multiple lenses configured horizontally.

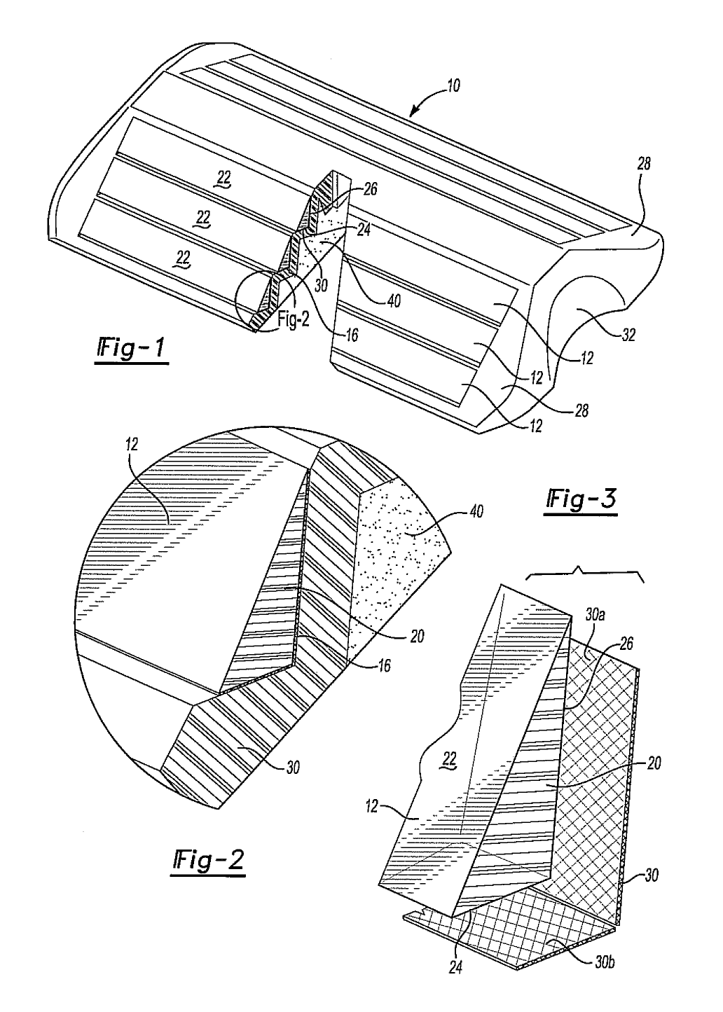

### DESCRIPTION OF THE INVENTION

A novel lens arrangement for reflective articles such as road markers is disclosed. The lens 12 has a planar outer surface 22 and one or more inner surfaces (24, 26) which are covered with a retroreflective or simply reflective sheeting material 30 The lens 12 has a planar outer surface 22 and one or more inner surfaces (24, 26) which are covered with the sheeting material 30. The outer surface 22 and rear surfaces 24, 26 are angled with respect to each other to form a prism and provide a desired angle of incidence on the sheeting 30. Let it be understood that the sheeting 30 may have either reflective or retroreflective characteristics, this description should not serve to limit claim coverage to either reflective or retroreflective characteristics. This description should clearly serve to cover both use of a reflective or retroflective sheeting 30.

The road marker 10 has lenses 12 with inner surfaces covered with the sheeting 30 and a shell 16 having a longitudinal trapezoidal cross section. The shell 16 has a top 18 surface between a pair of stepped angled surfaces 28 formed to the lenses. The lenses 12 are secured to the shell 16 with an acceptable adhesive. Furthermore, the lenses 12 are secured to the reflective retroreflective sheeting 30 by an adhesive, and the sheeting 30 attaches to the shell 16 by means of an adhesive. The adhesives used should be suitable so as to not disrupt or compromise the specific refractive index of the lens 12. It should be further understood that certain sheetings 30 have built in pressure sensitive adhesive enabling the requirement of having a suitable refractive index adhesive to assure continuity of light ray thru interfaces.

The lenses 12 are formed of glass or suitable plastic such as acrylic. Each lens has a planar outer surface 22 and planar rear surfaces 24, 26. A first rear surface 26 is angled at an angle θ_{R} with respect to the outer surface 22 of the lens 12. The rear surfaces 24, 26 are covered by the sheeting 30 such as Diamond Grade Translucent Reflective Sheeting produced by 3M Corporation. The shell 16 further includes an inner surface defining a cavity 40 wherein the cavity 40 is filled with a potting material to improve overall strength of the road marker.

An alternative embodiment of the lens 112 has a plurality of stepped portions as shown in FIG. 5. The stepped pattern is formed to minimize the thickness of lens 112. The shell 116 is modified to accommodate the lens 112. In this embodiment, the lens 112 is a one piece construction. A reflective or retroreflective sheeting 130 is disposed behind a first rear surface 126 and a second rear surface 124. The shell 116 further includes an inner surface defining a cavity 140 wherein the cavity 140 is filled with a potting material to improve overall strength of the road marker. Because of the limitations of the plastic injection molding process it is desirable to keep the maximum thickness “T” of the lens to less than 0.150″.

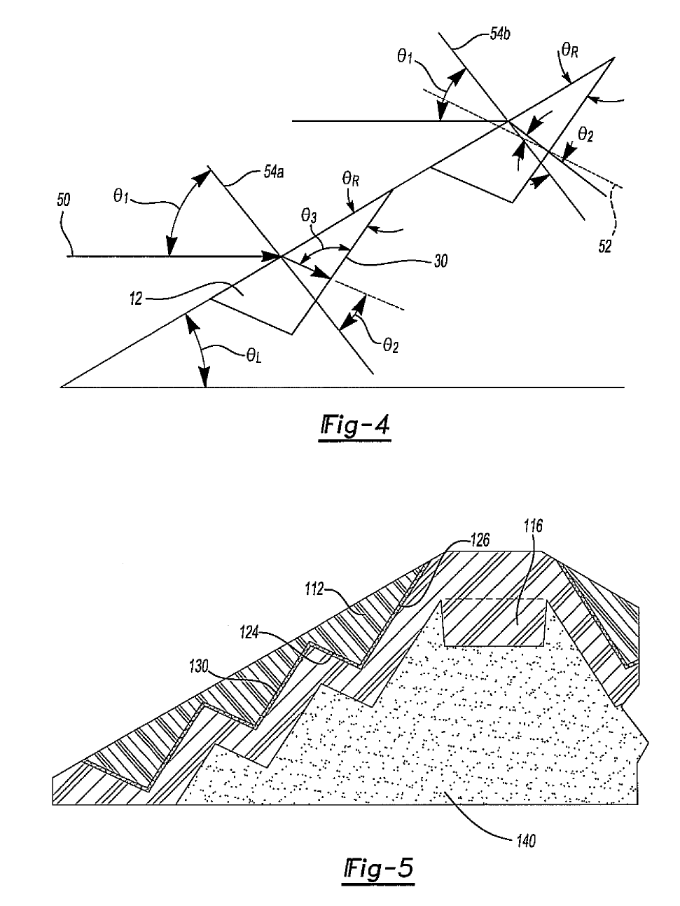

As shown in FIG. 4, light rays 50 from an approaching vehicle contacts the outer surface 22 of the lens 12 at an angle of incidence θ₁. Light rays 50 passing through the outer surface 22 of the lens 12 are bent to an angle θ₂ which is a function of the refractive index of the material from which the lens is produced. The relationship between the angle of incidence θ₁ and angle of refraction θ₂ may be expressed according to Snell's Law as N₁ sin θ₁=N₂ sin θ₂ where N₁ is refractive index of the material from where the light is coming and N₂ is the refractive index of the material which light passes through. For example, the refractive index for air is N₁=1.003 and the refractive index N₂ of acrylic plastic is 1.5. Using this formula, the angle θ_{L} of lens 12 to road surface and the angle θ_{R} of the first rear surface 26 to the outer surface 22 of the lens 12 may be selected so that light rays 50 passing through the outer surface 22 of the lens 12 to contact the first rear surface 26 of the lens 12 at a predetermined desired angle θ₃. In some cases θ₃ may be 90 degrees or may be offset from 90 degrees to interact with the reflective or retroreflective sheeting 30 material in a particular fashion. Incident light 52 is light lost and not reflected back to a user's viewing angle.

The sheeting 30 has the ability to redirect light rays 50 incident upon a surface of the sheeting 30 towards its originating source, such as a vehicle. There are many types of reflective or retroreflective sheeting 30 including crystal beads, cube corners, tetrahedral cube corners, pyramid cube corners, canted cube corners, etc. The sheeting 30 generally incorporates a structured surface including at least one array of reflective elements to enhance the visibility of an object. By orientating the optics of a cube corner, the sheeting 30 may be designed to exhibit optimal performance at a specific orientation. This may be accomplished by forming cube corner elements of the sheeting 30 such that their optical axes are canted relative to an axis perpendicular to the base plane and the sheeting. Additionally, gripping members 32 are provided on the shell 16 to ease install of the road marker 10.

U.S. Pat. No. 4,588,258 discloses sheeting 30 which employs optics having canted cube corner elements which form opposing matched pairs. The sheeting 30 exhibits a primary plane of improved retroreflective performance at high entrance angles identified as the X plane and a second plane of improved retroreflective performance identified as the Y plane. The axes can be canted in either a backward negative direction or a forward positive direction. Thus when reflective sheeting is applied to a lens such as the lens of a road marker, it is desirable to direct the light through the lens to the surface of the sheeting 30 at a desired angle which will result in the light being reflected back from the sheeting 30 to maximize reflectivity.

The amount of light reflected depends on the entrance angle θ₃ or angle of incidence. Thus for a −4 degree entrance angle θ₃, the amount of light reflected is greater than for a +30 degree entrance angle. The amount of light reflected varies with the divergence angle or observation angle. Thus it is desirable to orientate the surface of the reflective material with respect to the reflective property of the material. As shown in FIG. 4, the angle of the rear surface θ_{R} is selected with respect to the light passing through the lens not only to maximize the reflectivety by selecting but also return light to the driver at a desired angle to the outer surface of the lens. Incident light 52 from the vehicle will contact the lens at θ₁ with respect to normal width of the lens surface. Light is then refracted at θ₂ according to Snells law. Then, θ_{R} is selected to position the inner surface of the lens at the desired θ₃ to maximize the properties of the material. Using a prism-like lens and the sheeting 30, the angle of the lens outer surface to the road surface θ_{L} may be 30 degrees which is less than the conventional angle of 35 degrees. This results in a “softer” slope to the front and rear surfaces of the shell thereby making it easier for a tire to pass over the road marker, providing a softer, lower, jolt when the tire impacts the road marker.

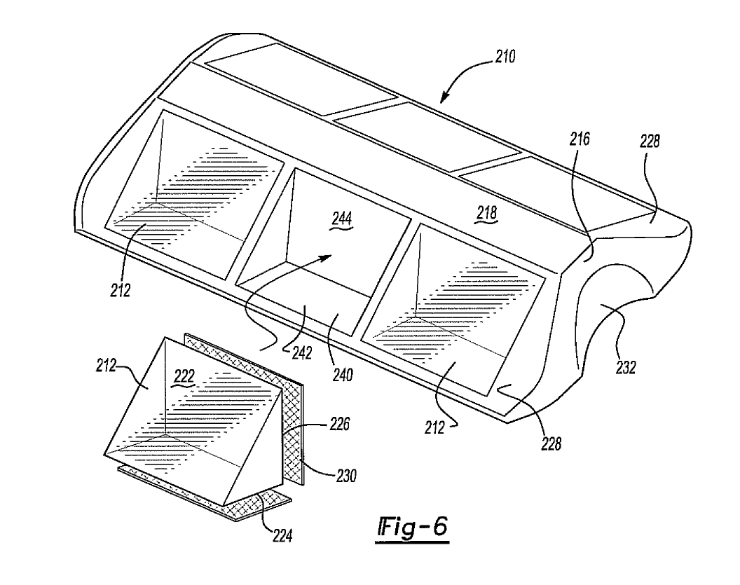

An alternative embodiment of the road marker 210 is depicted in FIG. 6 having six lenses 212 mounted on the shell 216. The lens 212 includes an outer surface 222 and rear surface 224, 226. The outer surface 222 of the lenses 212 is angled with respect to the rear surface 226 of the lens 212 to maximize efficiency of a sheeting 230 by allowing light entering the lens 212 from vehicle headlights to reflect efficiently back to the originating light emitted from the vehicle headlights. The lens 212 is mounted to each of the angled surfaces 228 of the shell 216. In yet another alternative embodiment, the lens 212 is a solid one piece construction lens (versus a plurality 212 lenses) extending horizontally on the angled surface 228 of the shell 216. The lens 212 rests within the cavity 240 having a bottom wall 242 and a back wall 244. The rear surface 224 of the lens 212 abuts the bottom wall 242 of the cavity 240, wherein the sheeting 230 is disposed between the bottom wall 242 and the rear surface 224. The rear surface 226 of the lens 212 abuts the back wall 244 of the cavity 240. The lens 212 is secured within the cavity 240, wherein the sheeting 230 is disposed between the back wall 242 and the rear surface 226.

Thus is disclosed a novel lens for an article such as a road marker which provides excellent retroreflectivity and may be produced inexpensively. The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

1. A road marker assembly for mounting on a road, the road marker assembly comprising:
a lens having a rear surface;
a shell having an outer surface, the lens mounted on the outer surface of the shell; and
a reflective layer disposed between the rear surface of the lens and the outer surface of the shell, the outer surface of the shell angled with respect to the rear surface of the lens to maximize efficiency of the reflective layer by allowing light entering the lens from vehicle headlights to reflect efficiently back to the originating light emitted from the vehicle headlights.

2. The road marker assembly of claim 1, wherein the rear surface of the lens is angled at a predetermined angle θ_{R} with respect to the outer surface of the shell, θ_{R} generated as a function of a predetermined index of refraction of the lens.

3. The road marker assembly of claim 2, wherein θ_{R} ranges between 5° and 30°.

4. The road marker assembly of claim 2, wherein the predetermined index of refraction ranges between 1.000 and 2.417.

5. The road marker assembly of claim 1, wherein the outer surface of the shell is angled at a predetermined angle θ_{L} with respect to ground the reflector assembly is mounted to.

6. The road marker assembly of claim 5, wherein θ_{L} ranges between 1 and 89°.

7. The road marker assembly of claim 1, wherein the outer surface of the shell includes a recess adapted to accept the lens.

8. The road marker assembly of claim 7, wherein the lens sits within the recess of the outer surface of the shell.

9. The road marker assembly of claim 8, wherein the reflective layer lines the recess and is disposed between the lens and the recess of the outer surface of the shell.

10. The road marker assembly of claim 1, wherein the lens has a planar outer surface.

11. The road marker assembly of claim 10, wherein the planar outer surface of the lens sits below a plane of the outer surface of the shell.

12. The road marker assembly of claim 1, wherein the shell includes an inner surface further defining a cavity defined by a generally trapezoidal cross section.

13. The road marker assembly of claim 1, wherein the shell is made of a polymer.

14. The road marker assembly of claim 1, wherein the shell is made of aluminum.

15. The road marker assembly of clam 1, wherein the reflective layer is further defined as a retroreflective layer.

16. The road marker assembly of claim 2, wherein an adhesive secures the lens to the shell.

17. The road marker assembly of claim 16, wherein the index of refraction of the adhesive securing the lens to the shell is suitable so as to not impact the overall index of refraction of the lens and adhesive combined.
